(19) United States
(12) Patent Application Publication
(10) Pub. No.: US 2026/0065069 A1
(43) Pub. Date: Mar. 5, 2026

(54) MACHINE LEARNING MODEL RECOVERY

(71) Applicant: HEWLETT PACKARD ENTERPRISE DEVELOPMENT LP, Spring, TX (US)

(72) Inventors: Omer Uretzky, Herzliya (IL); Gil Barash, Herzliya (IL)

(21) Appl. No.: 18/818,821

(22) Filed: Aug. 29, 2024

(51) Int. Cl. G06N 3/096

(52) U.S. Cl. CPC G06N 3/096

(57) ABSTRACT

In some examples, a system replicates modified parameters of a machine learning model to a journal, where the modified parameters relate to elements of a graph structure of the machine learning model, and the modified parameters in the journal are to be applied to a backup representation of the machine learning model. Based on receipt of a query associated with recovering a version of the machine learning model, the system builds the version of the machine learning model by retrieving a selected modified parameter from among the modified parameters in the journal and merge the selected modified parameter with a copy of the machine learning model represented by the backup representation of the machine learning model.

### BACKGROUND

Machine learning models can be used to make predictions based on an input collection of data. Training of a machine learning model involves updating parameters associated with the machine learning model.

### BRIEF DESCRIPTION OF THE DRAWINGS

Some implementations of the present disclosure are described with respect to the following figures.

FIG. 1 is a block diagram of an arrangement including a source repository storing a source model representation, a journal repository, and a backup repository storing a backup model representation, in accordance with some examples.

FIG. 2 is a block diagram of an example of creating a recovery neural network using the journal repository and the backup model representation, according to some examples.

FIG. 3 is a block diagram of a storage medium storing machine-readable instructions according to some examples.

FIG. 4 is a block diagram of a system according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Training a machine learning model can be time consuming and can involve extensive use of resources, including processing resources, storage resources, and communication resources. The machine learning model may be subjected to initial training, in which the machine learning model may be trained using a training data set. Moreover, after the initial training, the machine learning model may be updated based on further training to improve the accuracy of the machine learning model.

Storage system faults or errors may lead to loss or corruption of a machine learning model. Moreover, as the machine learning model is updated through multiple training iterations, there is a possibility that the machine learning model becomes corrupted (or otherwise modified in an unintended manner) due to use of incorrect training data or due to tampering of the training data by an attacker. If the machine learning model is lost or modified in an unintended manner, it may not be possible to revert the machine learning model to a prior state. As a result, the machine learning model may have to be recreated from scratch, which is wasteful of labor costs and resource usage. Additionally, unavailability of the machine learning model may lead to downtime if an organization is unable to perform operations that rely on the machine learning model.

In some examples, as the machine learning model is changed during training, different versions of the machine learning model may be backed up in a backup store. However, maintaining full copies of prior versions of the machine learning model can consume significant amounts of storage resources.

In accordance with some implementations of the present disclosure, different checkpoints for a machine learning model may be maintained by using a journal to which modified parameters of the machine learning model are replicated during training of the machine learning model. The journal stores just modified parameters of the machine learning model (i.e., the journal does not store unmodified parameters of the machine learning model). As a result, the amount of storage space consumed by the journal can be much smaller than that consumed by storing an entire machine learning model. In addition to the journal, a backup representation of the machine learning model can be maintained. The backup representation is a full copy of the machine learning model. Modified parameters in the journal can be applied (replayed) to update the backup representation of the machine learning model, either periodically or in response to another event (e.g., a user request, a quantity of modified parameters in the journal has exceeded a threshold, or any other event).

In response to a query to recover a target version of the machine learning model, a backup controller can build the target version of the machine learning model by retrieving selected modified parameters from the journal. The selected modified parameters from the journal in combination with the backup representation of the machine learning model are used in creating the target version of the machine learning model. This target version of the machine learning model can then be tested to confirm proper operation, and based on this confirmation, the target version of the machine learning model can be committed as the recovery version of the machine learning model.

An example of a machine learning model is a neural network, which includes a graph structure containing nodes (which are artificial neurons) and edges between the nodes. The nodes of the neural network can be included in layers of nodes. For example, a neural network can include an input layer, one or more hidden layers, and an output layer, where each layer includes a collection of nodes. Each node is connected to one or more other nodes. A neural network can be trained to improve the accuracy of the neural network. Each node (artificial neuron) receives one or more signals (either at the input of the neural network or from one or more other nodes of the neural network). The node processes the received signal(s) and generates an output signal sent to one or more other connected nodes. Weights can be associated with edges of the neural network. In an example, a first node can receive signals over input edges from other nodes. The weights associated with the input edges represent strengths of the signals received over the respective input edges. The first node generates an output signal based on the weights. The weights can be adjusted during training of the neural network.

The weights of a neural network are examples of model parameters that can be associated with a machine learning model. More generally, model parameters of a machine learning model are updated (modified) during training.

Another example of a machine learning model that includes a graph structure is a random forest model, which includes an ensemble of decision trees. A decision tree includes nodes and edges connecting the nodes. The random forest model includes model parameters that can be updated during training.

The ensuing discussion refers to examples that employ neural networks. In other examples, techniques or mechanisms according to some implementations of the present disclosure can be applied to other types of machine learning models that include graph structures.

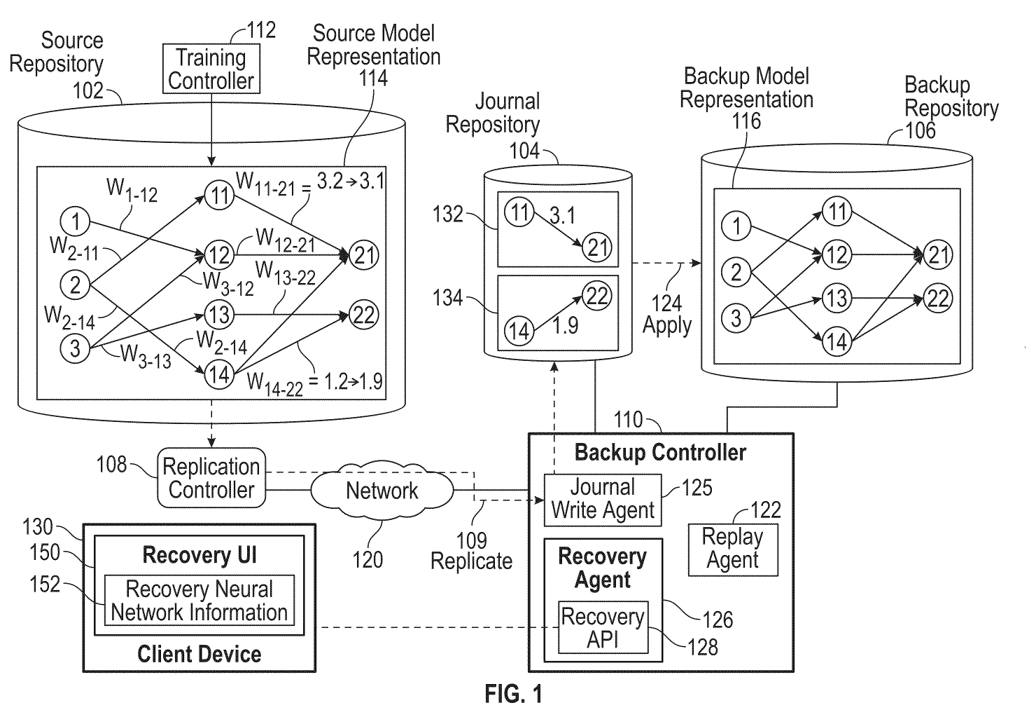

FIG. 1 is a block diagram of an example arrangement that includes a source repository 102, a journal repository 104, and a backup repository 106. A "repository" can refer to any storage structure that contains information. Examples of repositories can include databases, files, or other types of storage structures. A repository can be stored in one or more storage devices.

Although the example of FIG. 1 shows one source repository 102, in other examples, there may be multiple source repositories. Similarly, in other examples, there may be multiple backup repositories and/or multiple journal repositories. The source repository 102 contains a source model representation 114 of a neural network that is to be protected from data loss or corruption by replicating the source model representation 114 to another storage structure.

The journal repository 104 is a repository that stores, in respective journal entries of the journal repository, modified weights that were updated during training of the neural network. A journal entry can include an indication of an edge that a modified weight is associated with. The indication can be in the form of identifiers of the nodes connected by the edge, or some other identifier of an edge.

In some examples, it is noted that the graph structure of a neural network (e.g., the neural network represented by the source model representation 114) does not change. In other words, the nodes and the edges connecting the nodes of the neural network remain unchanged during training of the neural network. What changes are the weights associated with edges of the neural network. Since the graph structure of the neural network does not change, the journal entries of the journal repository 104 can store just the modified weights and indications of edges that the modified weights are associated with. The journal entries do not have to store information describing the graph structure of the neural network. As a result, the size of the journal repository 104 can be kept relatively small (as compared to the size of a representation of a full neural network).

The journal entries can be applied to a backup model representation 116 contained in the backup repository 106. Application of the journal entries to the backup model representation 116 causes an update of respective weights in the backup model representation 116.

The backup model representation 116 in the backup repository 106 includes a copy of the neural network represented by the source model representation 114. If the journal repository 104 is not empty, then the backup model representation 116 is out of date with respect to the source model representation 114; in other words, at least one weight in the backup model representation 116 is out of date with respect to at least one corresponding weight in the source model representation 114.

The example arrangement of FIG. 1 also includes a replication controller 108 and a backup controller 110. Although shown as two separate controllers, it is noted that in other examples, the replication controller 108 and the backup controller 110 can be integrated into one controller. In further examples, functionalities of the replication controller 108 and/or the backup controller 110 may be separated into additional controllers.

In addition, a training controller 112 can be used to train the neural network represented by the source model representation 114. Training the neural network results in updates of one or more weights of the neural network.

As used here, a "controller" can refer to one or more hardware processing circuits, which can include any or some combination of a microprocessor, a core of a multi-core microprocessor, a microcontroller, a programmable integrated circuit, a programmable gate array, or another hardware processing circuit. Alternatively, a "controller" can refer to a combination of one or more hardware processing circuits and machine-readable instructions (software and/or firmware) executable on the one or more hardware processing circuits.

In the example of FIG. 1, the neural network represented by the source model representation 114 includes nodes represented by circles. The neural network includes an input layer containing nodes N1, N2, and N3, a hidden layer containing nodes N11, N12, N13, and N14, and an output layer containing nodes N21 and N22. Although specific quantities of nodes and layers are shown in FIG. 1, in other examples, the neural network can include different quantities of nodes and layers.

Edges connecting the nodes of the neural network are associated with weights. Generally, a weight W_{X-Y} is associated with an edge that connects node X and node Y. For example, a weight W₁₁₋₂₁ is associated with an edge connecting nodes N11 and N21, and a weight W₁₄₋₂₂ is associated with an edge connecting nodes N14 and N22.

Initially, prior to training of the neural network, initial weights are associated with respective edges of the neural network. In some examples, the initial weights can include random weights. In other examples, the initial weights can include zero or null weights. As the neural network is trained, updated weights can be assigned to at least some of the edges. As the neural network is further refined, one or more of the weights may be further modified.

In the example of FIG. 1, refinements of the neural network after initial training have caused the value of the weight W₁₁₋₂₁ to be changed from 3.2 to 3.1, and the value of the weight W₁₄₋₂₂ to be changed from 1.2 to 1.9.

The replication controller 108 replicates (at 109), over a network 120, the modified weights (including W₁₁₋₂₁ and W₁₄₋₂₂) to the journal repository 104. The replication is performed through a journal write agent 125 in the backup controller 110. The modified weights are replicated into respective journal entries 132 and 134 of the journal repository 104. The modified weight W₁₁₋₂₁ is added to the journal entry 132, and the modified weight W₁₄₋₂₂ is added to the journal entry 134. Along with the value of the modified weight, each journal entry 132 or 134 also includes an indication of an edge that the modified weight is associated with. The indication can be in the form of identifiers of the nodes connected by the edge, or some other identifier of an edge.

Prior to application of the journal entries 132 and 134 to the backup model representation 116, the backup model representation 116 represents a neural network with weights that are set to values prior to the modification of weights W₁₁₋₂₁ and W₁₄₋₂₂. Thus, for example, prior to application of the journal entries 132 and 134 to the backup model representation 116, a copy of the neural network represented by the backup model representation 116 has W₁₁₋₂₁ set to 3.2 (instead of the updated value 3.1), and weight W₁₄₋₂₂ set to 1.2 (instead of updated value 1.9).

The backup controller 110 includes the journal write agent 125 to write journal entries to the journal repository 104, in response to replicate requests from the replication controller 108. A replicate request can include a request to replicate one or more write events to the journal repository 104. The journal write agent 125 generates write commands to write respective journal entries to the journal repository 104. An "agent" in a controller can refer to a portion of the hardware processing circuitry of the controller, or to machine-readable instructions executed by the controller.

The backup controller 110 includes a replay agent 122 that is to apply (at 124) the journal entries 132 and 134 in the journal repository 104 to the backup model representation 116. The replay agent 122 can apply (at 124) the journal entries to the backup model representation 116 in response to a user request, or in response to another trigger (e.g., a periodic trigger associated with periodically applying journal entries to the backup model representation 116, or any other type of trigger). In some examples, the journal entries are applied to the backup model representation 116 in the same order as the journal entries were added to the journal repository 104. After applying the journal entries in the journal repository 104 to the backup model representation 116, the journal entries can be removed from the journal repository 104.

The backup controller 110 further includes a recovery agent 126 that can recover a target version of the neural network based on content of the journal repository 104 and the backup model representation 116. The target version of the neural network can be a version of the neural network that is prior to a current version of the neural network. The target version of the neural network is referred to as a "recovery neural network" that can be used to replace a corrupted or lost neural network.

In some examples, the recovery agent 126 includes a recovery application programming interface (API) 128 that is accessible to client devices, such as a client device 130. The recovery API 128 includes various routines that can be invoked by the client device 130 to perform a model recovery operation. For example, in response to a request of a user or another entity at the client device 130, the client device 130 can invoke a routine of the recovery API 128 to initiate the model recovery operation. The invoked routine of the recovery API 128 can send a recovery query to the journal repository 104 and the backup repository 106 to recover the target version of the neural network.

A "recovery query" refers to a query that is submitted to retrieve data for recovering a neural network. The recovery query can include a filter specifying one or more criteria (or predicates). Any journal entries of the journal repository 104 that satisfy the filter are retrieved from the journal repository 104. The retrieved journal entries are merged with the backup model representation 116 to produce the target version of the neural network.

In other examples, instead of the recovery API 128, the recovery agent 126 can include another type of interface accessible to client devices for initiating recovery queries.

In some examples, the client device 130 includes a recovery user interface (UI) 150, such as a graphical user interface (GUI), a command line interface, or another type of interface. A user of the client device 130 can input requests into the recovery UI 150 to initiate a model recovery operation. As part of the request, the user can specify the checkpoint (corresponding to a point in time version of the neural network, for example) in the journal repository 104 that is to be used for recovering the neural network, such as for disaster recovery or for testing. Checkpoints are discussed further below. In response to the requests input into the recovery UI 150, the client device 130 invokes a routine of the recovery API 128 to perform the model recovery operation. Further, the user can specify, in the recovery UI 150, which neural network is to be protected using techniques according to some examples of the present disclosure.

Once the recovery agent 126 has generated a recovery neural network in response to the recovery query, the recovery agent 126 sends to the client device 130 recovery neural network information 152 that can be presented in the recovery UI 150. The recovery neural network information 152 can include a name (or another identifier) of the recovery neural network. The user of the client device 130 can then submit requests to use the recovery neural network. This use may include testing of the recovery neural network to determine if the recovery neural network is operating as expected. If not, the user may initiate another model recovery operation to recover the neural network using another checkpoint.

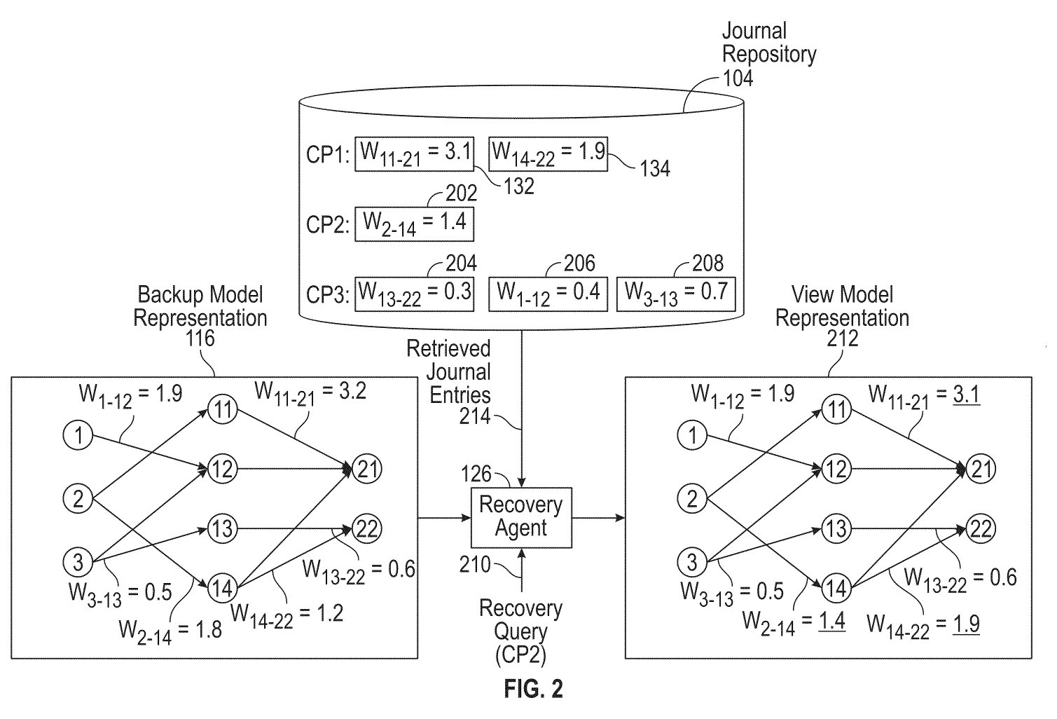

The filter of a recovery query can specify a selected checkpoint to use in generating a recovery neural network. The modified weights of the neural network replicated to the journal repository 104 can be part of different checkpoints. For example, as shown in FIG. 2, three checkpoints CP1, CP2, and CP3 have been added to the journal repository 104. A "checkpoint" includes data of the neural network at a respective time point. Different checkpoints in the journal repository 104 can be created at different time points. Each checkpoint can include one or more journal entries. In some examples, journal entries can be assigned to respective checkpoints in the following manner. Initially, a first checkpoint is defined in the journal repository 104. As journal entries are added to the journal repository 104, such journal entries are assigned to the first checkpoint. After passage of a specified checkpoint time interval, a second checkpoint is defined in the journal repository 104, and subsequent journal entries are assigned to the second checkpoint. More generally, with each passage of the specified checkpoint time interval, a new checkpoint is defined in the journal repository 104. More generally, other types of triggers (e.g., triggers relating to different training phases of the neural network) may cause a new checkpoint to be defined in the journal repository 104.

For example, checkpoint CP1 includes the journal entries 132 and 134. The journal entry 132 includes modified weight W₁₁₋₂₁, and the journal entry 134 includes modified weight W₁₄₋₂₂. Checkpoint CP2 includes a journal entry 202 containing modified weight W₂₋₁₄. Checkpoint CP3 includes journal entries 204, 206, and 208. The journal entry 204 includes modified weight W₁₃₋₂₂, the journal entry 206 includes modified weight W₁₋₁₂, and the journal entry 208 includes modified weight W₃₋₁₃.

The checkpoints CP1 to CP3 contain modified data at respective different time points. In an example, checkpoint CP2 is created at a later time than checkpoint CP1, and checkpoint CP3 is created at a later time than checkpoint CP2. In the example of FIG. 2, the recovery agent 126 has received a recovery query 210 including a filter that specifies checkpoint CP2. The recovery query 210 may have been provided in response to a request from the client device 130 of FIG. 1, for example.

In response to the recovery query 210 specifying checkpoint CP2, the recovery agent 126 retrieves, from the journal repository 104, the journal entry 202 of checkpoint CP2 and the journal entries of any prior checkpoints, including the journal entries 132 and 134 of checkpoint CP1. The recovery agent 126 merges the retrieved journal entries 214 from checkpoints CP1 and CP2 with the copy of the neural network represented by the backup model representation 116 to generate a recovery neural network represented by a view model representation 212.

In the example of FIG. 2, the copy of the neural network represented by the backup model representation 116 includes the following weight values: W₁₋₁₂ = 1.9 (which has been updated as indicated by the journal entry 206 in checkpoint CP3), W₃₋₁₃ = 0.5 (which has been updated as indicated by the journal entry 208 in checkpoint CP3), W₂₋₁₄ = 1.8 (which has been updated as indicated by the journal entry 202 in checkpoint CP2), W₁₁₋₂₁ = 3.2 (which has been updated as indicated by the journal entry 132 in checkpoint CP1), and W₁₄₋₂₂ = 1.2 (which has been updated as indicated by the journal entry 134 in checkpoint CP1). Weights of other edges of the copy of the neural network are not shown.

To generate the view model representation 212, the recovery agent 126 applies the retrieved journal entries 214 to the copy of the neural network. As a result of applying the retrieved journal entries 214, the recovery neural network represented by the view model representation 212 has the following weight values: W₁₋₁₂ = 1.9 (this weight value is not updated in the recovery neural network because the journal entry 206 in checkpoint CP3 has not been selected for recovery), W₃₋₁₃ = 0.5 (this weight value is not updated in the recovery neural network because the journal entry 208 in checkpoint CP3 has not been selected for recovery), W₂₋₁₄ = 1.4 (this weight value has been updated in the recovery neural network because the journal entry 202 in checkpoint CP2 is selected for recovery), W₁₁₋₂₁ = 3.1 (this weight value has been updated in the recovery neural network because the journal entry 132 in checkpoint CP1 is selected for recovery), W₁₃₋₂₂ = 0.6 (this weight value is not updated in the recovery neural network because the journal entry 208 in checkpoint CP3 has not been selected for recovery), and W₁₄₋₂₂ = 1.9 (this weight value has been updated in the recovery neural network because the journal entry 134 in checkpoint CP1 is selected for recovery). Weights of other edges of the recovery neural network are not shown.

In a specific example, the recovery agent 126 merges the journal entries with the backup model representation 116 by partially building the recovery neural network using the selected journal entries retrieved from the journal repository 104, and completing a remainder of the recovery neural network using backup weights retrieved from the backup model representation 116. Partially building the recovery neural network includes assigning modified weights of the selected journal entries to respective edges of the recovery neural network. Completing the remainder of the recovery neural network includes assigning the backup weights associated with edges of the copy of the neural network represented by the backup model representation 116 to any edges to which modified weights of the selected journal entries were not assigned.

The recovery agent 126 can send information of the view model representation 212 to a client device (e.g., the client device 130 of FIG. 1). This information can be used by a user of the client device (or another entity at the client device) to use the recovery neural network represented by a view model representation 212. For example, the user or another entity can test the recovery neural network to determine the accuracy or performance of the recovery neural network. If the recovery neural network performs as expected, then the user or another entity can commit the recovery neural network to use as a replacement of the current neural network represented by the source model representation 114.

Using techniques or mechanisms according to some examples of the present disclosure, the protection of a neural network can be accomplished in an efficient manner by using a relatively small size journal repository with journal entries that can be selected based on a recovery query to combine with a backup model representation of a copy of the neural network to generate a recovery neural network. The generation of a recovery neural network can be accomplished with a relatively recovery point objective (RPO) and recovery time objective (RTO). RPO refers to the amount of data that will be lost in case of model corruption or loss. By providing checkpoints at relatively small time intervals (e.g., a checkpoint every five seconds or another time interval), a requester can select a relatively recent version of a neural network so that data loss can be reduced.

RTO refers to the length of downtime. The recovery agent 126 can quickly merge selected journal entries of the journal repository with a backup model representation to generate a recovery neural network. As a result, downtime until the recovery neural network is provided can be reduced.

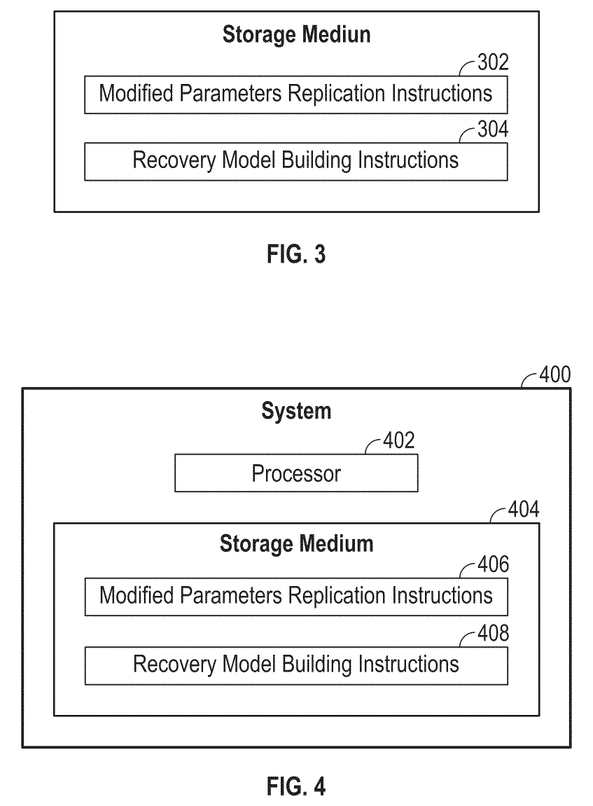

FIG. 3 is a block diagram of a non-transitory machine-readable or computer-readable storage medium 300 storing machine-readable instructions that upon execution cause a system to perform various tasks. The system can be implemented with one or more computers, and may include the replication controller 108 and the backup controller 110 of FIG. 1, for example.

The machine-readable instructions include modified parameters replication instructions 302 to replicate modified parameters of a machine learning model to a journal. The modified parameters relate to elements of a graph structure of the machine learning model, and the modified parameters in the journal are to be applied to a backup representation of the machine learning model. Examples of the machine learning model can include any or some combination of the following: a neural network, a random forest model, or any other machine learning model including a graph structure. The elements of the graph structure can include edges that interconnect nodes of the graph structure. Alternatively, the elements of the graph structure can include nodes of the graph structure, trees within the graph structure, or any other elements that form the graph structure.

The machine-readable instructions include recovery model building instructions 304 to, based on receipt of a recovery query associated with recovering a target version of the machine learning model, build the target version of the machine learning model by retrieving a selected modified parameter from among the modified parameters in the journal and merge the selected modified parameter with a copy of the machine learning model represented by the backup representation of the machine learning model. Retrieving the selected modified parameter from the journal can refer to retrieving a single modified parameter from the journal or retrieving multiple modified parameters from the journal.

In some examples, the merging includes assigning the selected modified parameter to an element of a graph structure of the copy of the machine learning model, where the selected modified updates a prior parameter (referred to as a “backup parameter”) assigned to the element of the graph structure of the copy of the machine learning model.

In further examples, the merging includes partially building the target version of the machine learning model using the selected modified parameter retrieved from the journal, and completing a remainder of the version of the machine learning model using the backup parameters retrieved from the backup representation of the machine learning model.

In some examples, the query specifies a first checkpoint of a plurality of checkpoints relating to corresponding different versions of the machine learning model, and the selected modified parameter retrieved from the journal is based on the first checkpoint specified by the query.

In some examples, the machine-readable instructions can retrieve a plurality of selected modified parameters from the journal in response to the query, where the plurality of selected modified parameters includes a modified parameter in the first checkpoint, and a modified parameter in a second checkpoint prior to the first checkpoint. The machine-readable instructions can merge the plurality of selected modified parameters with the copy of the machine learning model represented by the backup representation of the machine learning model to build the target version of the machine learning model.

In some examples, each checkpoint of the plurality of checkpoints comprises one or more modified parameters relating to respective one or more elements of the graph structure.

In some examples, the modified parameters are produced as part of training the machine learning model.

In some examples, the journal stores the modified parameters of the machine learning model and does not store unmodified parameters of the machine learning model.

In some examples, the graph structure of the machine learning model remains unchanged while parameters relating to elements of the graph structure are changed based on training of the machine learning model.

In some examples, the machine-readable instructions can apply the modified parameters in the journal to the backup representation of the machine for updating the backup representation of the machine learning model. The machine-readable instructions can remove the modified parameters from the journal in response to applying the modified parameters to the backup representation of the machine learning model.

FIG. 4 is a block diagram of a system 400 according to some examples, which can be implemented with one or more computers. The system 400 includes a hardware processor 402 (or multiple hardware processors). A hardware processor can include a microprocessor, a core of a multi-core microprocessor, a microcontroller, a programmable integrated circuit, a programmable gate array, or another hardware processing circuit.

The system 400 includes a storage medium 404 storing machine-readable instructions executable on the hardware processor 402 to perform various tasks. Machine-readable instructions executable on a hardware processor can refer to the instructions executable on a single hardware processor or the instructions executable on multiple hardware processors.

The machine-readable instructions in the storage medium 404 include modified parameters replication instructions 406 to replicate modified parameters of a machine learning model to a journal, where the modified parameters relate to elements of a graph structure of the machine learning model, and the modified parameters in the journal are to be applied to a backup representation of the machine learning model.

The machine-readable instructions in the storage medium 404 include recovery model building instructions 408 to, based on receipt of a query associated with recovering a version of the machine learning model, build the version of the machine learning model by retrieving a selected modified parameter from among the modified parameters in the journal and merge the selected modified parameter with a copy of the machine learning model represented by the backup representation of the machine learning model.

In some examples, the journal includes a plurality of checkpoints corresponding to different time points, where a first checkpoint includes one or more first modified parameters for the machine learning model, and a second checkpoint includes one or more second modified parameters for the machine learning model. The recovery query specifies a checkpoint, and the selected modified parameter retrieved from the journal is based on the checkpoint specified by the query.

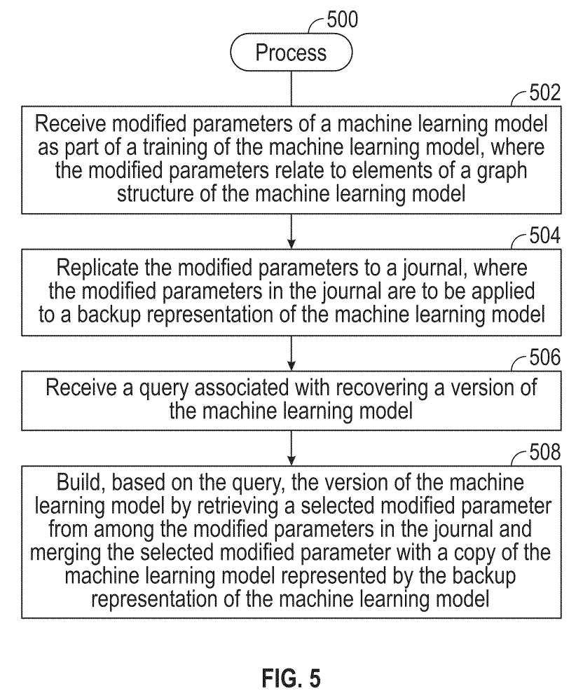

FIG. 5 is a flow diagram of a process 500 according to some examples, which may be performed by the replication controller 108 and the backup controller 110 of FIG. 1, for example.

The process 500 includes receiving (at 502) modified parameters of a machine learning model as part of a training of the machine learning model, where the modified parameters relate to elements of a graph structure of the machine learning model. The elements can include edges, nodes, or other elements that form the graph structure.

The process 500 includes replicating (at 504) the modified parameters to a journal, where the modified parameters in the journal are to be applied to a backup representation of the machine learning model. The modified parameters can be added to journal entries in the journal. The journal entries can be part of one or more checkpoints in the journal.

The process 500 includes receiving (at 506) a query associated with recovering a version of the machine learning model. The query can specify one of the checkpoints.

The process 500 includes building (at 508), based on the query, the version of the machine learning model by retrieving a selected modified parameter from among the modified parameters in the journal and merging the selected modified parameter with a copy of the machine learning model represented by the backup representation of the machine learning model.

In some examples, the process 500 tests the version of the machine learning model built using the journal and the backup representation of the machine learning model.

In some examples, based on the testing, the process 500 commits the version of the machine learning model to use in recovering the machine learning model.

Examples of a client device (e.g., 130 in FIG. 1) can include any or some combination of the following: a desktop computer, a notebook computer, a smartphone, or any other type of electronic device.

A "network" (e.g., 120 in FIG. 1) can refer to a local area network (LAN), a wide area network (WAN), the Internet, a storage area network (SAN), or any other type of communication fabric.

A storage medium (e.g., 300 in FIG. 3 or 404 in FIG. 4) can include any or some combination of the following: a semiconductor memory device such as a dynamic or static random access memory (a DRAM or SRAM), an erasable and programmable read-only memory (EPROM), an electrically erasable and programmable read-only memory (EEPROM), and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term "a," "an," or "the" is intended to include the plural forms as well, unless the context clearly indicates otherwise. Also, the term "includes," "including," "comprises," "comprising," "have," or "having" when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
replicate modified parameters of a machine learning model to a journal, wherein the modified parameters relate to elements of a graph structure of the machine learning model, and the modified parameters in the journal are to be applied to a backup representation of the machine learning model; and
based on receipt of a query associated with recovering a version of the machine learning model, build the version of the machine learning model by retrieving a selected modified parameter from among the modified parameters in the journal and merge the selected modified parameter with a copy of the machine learning model represented by the backup representation of the machine learning model.

2. The non-transitory machine-readable storage medium of claim 1, wherein the merging comprises:
assigning the selected modified parameter to an element of a graph structure of the copy of the machine learning model, the selected modified updating a prior parameter assigned to the element of the graph structure of the copy of the machine learning model.

3. The non-transitory machine-readable storage medium of claim 2, wherein the elements of the graph structure comprise edges connecting nodes in the graph structure.

4. The non-transitory machine-readable storage medium of claim 3, wherein the machine learning model comprises a neural network, and the selected modified parameter from the journal comprises a modified weight of an edge of the neural network.

5. The non-transitory machine-readable storage medium of claim 1, wherein the query specifies a first checkpoint of a plurality of checkpoints relating to corresponding different versions of the machine learning model, and the selected modified parameter retrieved from the journal is based on the first checkpoint specified by the query.

6. The non-transitory machine-readable storage medium of claim 5, wherein the instructions upon execution cause the system to:
retrieve a plurality of selected modified parameters from the journal in response to the query, wherein the plurality of selected modified parameters comprises a modified parameter in the first checkpoint, and a modified parameter in a second checkpoint prior to the first checkpoint; and merge the plurality of selected modified parameters with the copy of the machine learning model represented by the backup representation of the machine learning model to build the version of the machine learning model.

7. The non-transitory machine-readable storage medium of claim 5, wherein each checkpoint of the plurality of checkpoints comprises one or more modified parameters relating to respective one or more elements of the graph structure.

8. The non-transitory machine-readable storage medium of claim 1, wherein the modified parameters are produced as part of training the machine learning model.

9. The non-transitory machine-readable storage medium of claim 1, wherein the journal stores the modified parameters of the machine learning model and does not store unmodified parameters of the machine learning model.

10. The non-transitory machine-readable storage medium of claim 9, wherein the graph structure of the machine learning model remains unchanged while parameters relating to elements of the graph structure are changed based on training of the machine learning model.

11. The non-transitory machine-readable storage medium of claim 1, wherein the merging comprises:
partially building the version of the machine learning model using the selected modified parameter retrieved from the journal, and completing a remainder of the version of the machine learning model using backup parameters retrieved from the backup representation of the machine learning model.

12. The non-transitory machine-readable storage medium of claim 1, wherein the instructions upon execution cause the system to:
apply the modified parameters in the journal to the backup representation of the machine learning model to update the backup representation of the machine learning model; and remove the modified parameters from the journal in response to applying the modified parameters to the backup representation of the machine learning model.

13. A method comprising:
receiving, at a system comprising a hardware processor, modified parameters of a machine learning model as part of a training of the machine learning model, wherein the modified parameters relate to elements of a graph structure of the machine learning model; replicating, by the system, the modified parameters to a journal, wherein the modified parameters in the journal are to be applied to a backup representation of the machine learning model; receiving, by the system, a query associated with recovering a version of the machine learning model; and based on the query, building, by the system, the version of the machine learning model by retrieving a selected modified parameter from among the modified parameters in the journal and merging the selected modified parameter with a copy of the machine learning model represented by the backup representation of the machine learning model.

14. The method of claim 13, further comprising:
testing the version of the machine learning model built using the journal and the backup representation of the machine learning model.

15. The method of claim 14, further comprising:
based on the testing, committing the version of the machine learning model to use in recovering the machine learning model.

16. The method of claim 13, wherein the journal comprises a plurality of checkpoints corresponding to different time points, wherein a first checkpoint comprises one or more first modified parameters for the machine learning model, and a second checkpoint comprises one or more second modified parameters for the machine learning model, wherein the query specifies a checkpoint, and wherein the selected modified parameter retrieved from the journal is based on the checkpoint specified by the query.

17. A system comprising:
a processor; and
a non-transitory storage medium storing instructions executable on the processor to:
replicate modified parameters of a machine learning model to a journal, wherein the modified parameters relate to elements of a graph structure of the machine learning model, and the modified parameters in the journal are to be applied to a backup representation of the machine learning model; and
based on receipt of a query associated with recovering a version of the machine learning model, build the version of the machine learning model by retrieving a selected modified parameter from among the modified parameters in the journal and merge the selected modified parameter with a copy of the machine learning model represented by the backup representation of the machine learning model.

18. The system of claim 17, wherein the machine learning model comprises a neural network, and the modified parameters relate to edges of the neural network.

19. The system of claim 17, wherein the journal comprises a plurality of checkpoints corresponding to different time points, wherein a first checkpoint comprises one or more first modified parameters for the machine learning model, and a second checkpoint comprises one or more second modified parameters for the machine learning model, wherein the query specifies a checkpoint, and wherein the selected modified parameter retrieved from the journal is based on the checkpoint specified by the query.

20. The system of claim 19, wherein the instructions are executable on the processor to:
retrieve a plurality of selected modified parameters from the journal in response to the query, wherein the plurality of selected modified parameters comprises a modified parameter in the first checkpoint, and a modified parameter in the second checkpoint that is prior to the first checkpoint; and merge the plurality of selected modified parameters with the copy of the machine learning model represented by the backup representation of the machine learning model to build the version of the machine learning model.
